(19) United States
(12) Patent Application Publication
(10) Pub. No.: US 2015/0148843 A1
(43) Pub. Date: May 28, 2015

(54) Liquid Dispensing Pacifier with Interchangeable Parts

(71) Applicant: Justin Turley, Idaho Falls, ID (US)

(72) Inventor: Justin Turley, Idaho Falls, ID (US)

(21) Appl. No.: 14/511,210

(22) Filed: Oct. 10, 2014

Related U.S. Application Data
(60) Provisional application No. 61/909,764, filed on Nov. 27, 2013.

(51) Int. Cl. A61J 17/00

(52) U.S. Cl. CPC A61J 17/00; A61J 2017/006
USPC 606/234

(57) ABSTRACT

A liquid dispensing pacifier having interchangeable components is provided. The pacifier includes a hollow, porous nipple secured to a shield and having a base thereon for attachment to other components. The nipple can be disposed directly on the opening of a baby bottle for feeding, or to a syringe to facilitate administration of medicine. Alternatively, the pacifier can be secured to one end of an elongated straw and the straw can be threaded through a lid secured to a baby bottle and disposed within the liquid content therein. In this way, a baby can suck on the pacifier to draw liquid from the bottle without having to hold the bottle. Additionally, the straw can be secured to the pacifier, and the pacifier can be attached directly to a baby bottle to feed a baby in the conventional manner.

### CROSS REFERENCE TO RELATED APPLICATION

This application claims the benefit of U.S. Provisional Application No. 61/909,764 filed on Nov. 27, 2013, entitled “Binky Bottle.” The above identified patent application is herein incorporated by reference in its entirety to provide continuity of disclosure.

### BACKGROUND OF THE INVENTION

1. Field of the Invention

The present invention relates to a liquid dispensing pacifier. More specifically, the present invention describes a liquid dispensing pacifier comprising a nipple that can be used by itself as a conventional pacifier, or that can be removably secured to a container such as a bottle or a syringe. The nipple can further be secured to an elongated straw having an end positioned within a container so that a baby can suck on the nipple to draw liquid therethrough without having to hold the bottle. The present invention allows a user to assemble the liquid dispensing pacifier in a variety of configurations and with various containers as desired so as to eliminate the need for the parent or guardian to purchase several different types of pacifiers and feeding devices for a baby.

Parents may experience difficulty teaching their baby to use a bottle. Babies are often unable to grasp and hold a bottle so that the baby can drink therefrom. This is particularly true where the bottle is full and is heavy. Thus, in order to transition the baby from breastfeeding to using a bottle, a parent must hold the bottle to feed the baby until the time when the baby can do so by himself or herself.

It is important for the baby to learn how to drink from a bottle without the need for a parent to hold the bottle. This allows the baby to drink as much as desired, and eliminates the need for the parent to guess how much the baby wishes to drink. Further, babies may not accept and may not eat food, drinks, or medicine administered by force. Babies may be more receptive to such items if the baby can consume the substance on their own accord.

Parents are not always able to hold a bottle for their baby. Parents or guardians may take the baby on a walk in a stroller, and in such cases the parent is not able to simultaneously push the stroller and hold a bottle. While a variety of baby feeding devices are known and can be used for a variety of purposes, such items can consume substantial space and require the parent or guardian to purchase several different devices. Thus, a liquid dispensing pacifier that can be variously configured and that can help a baby to drink without the need for a parent to hold a bottle is desired.

The present invention provides a liquid dispensing pacifier having a variety of interchangeable components in order to allow the user to assemble the pacifier in a variety of configurations. The liquid dispensing pacifier can be used as a conventional pacifier, or it can be secured to a container such as a bottle or a syringe. The pacifier comprises a hollow, porous nipple secured to a shield, and having a base that can be secured to containers and to an elongated straw. One end of the elongated straw can be secured to the base of the pacifier, and the other end can be disposed within a bottle or other container.

### DESCRIPTION OF THE PRIOR ART

Devices have been disclosed in the prior art that relate to baby feeding devices. These include devices that have been patented and published in patent application publications. These devices generally relate to liquid dispensing pacifiers. The following is a list of devices deemed most relevant to the present disclosure, which are herein described for the purposes of highlighting and differentiating the unique aspects of the present invention, and further highlighting the drawbacks existing in the prior art.

One such prior art device is U.S. Pat. No. 4,867,159 to Fulton, which discloses a fillable pacifier comprising a nipple, a handle, and a cover. The nipple can be filled with a liquid or jelly substance and sealed to the main body of the pacifier. The pacifier also includes a shield extending from the outer portion of the pacifier. Thus, Fulton provides a reusable pacifier that can be filled with liquid for use by a baby. Fulton fails to disclose a liquid dispensing pacifier comprising a pacifier that can be secured to a baby bottle such that the baby can drink from the baby bottle. Further, Fulton does not disclose an elongated straw that can be connected to a pacifier at one end and disposed within a container at the other end.

U.S. Pat. No. 5,354,274 to Demeter et al. discloses a pacifier device adapted to facilitate the oral administration of liquids. The device receives sealed cartridges that are filled with pre-measured liquid nutrients or medications, and the device breaches the cartridges so that the liquid can flow into a hollow nipple. The hollow nipple allows a user to consume liquid released from the cartridges. While Demeter discloses a liquid dispensing pacifier, the nipple in Demeter is not adapted to be secured to various containers such as bottles and syringes, and does not include an elongated straw that can be secured to the pacifier and disposed within a container. Thus, Demeter does not allow the user to assemble the pacifier into various configurations.

U.S. Pat. No. 2,612,165 to Szuderski discloses a pacifier device having a nipple and a container in which a substance such as medication can be positioned. The nipple is porous and a baby can suck on the nipple to draw the substance therethrough. Thus, Szuderski provides a device that allows a user to insert a container filled with a consumable substance into a nipple. However, Szuderski does not disclose a nipple that can be secured to various receptacles such as a bottle or a syringe in order to allow a baby to feed therefrom.

U.S. Pat. No. 5,176,705 to Noble discloses a pacifier having a hollow nipple disposed within a cylindrical sleeve. The sleeve has threading thereon and engages with a cap that seals the nipple to prevent fluid from escaping therefrom. The pacifier is adapted to store and administer a specific dosage of liquid medication. Thus, Noble fails to disclose a nipple that can be removably secured to an elongated straw that can be disposed within a container so as to allow a baby to suck on the nipple to draw fluid through the straw.

U.S. Pat. No. 5,662,684 to Caso discloses a liquid dispensing pacifier having a body with a nipple secured to one end thereof. The body contains a reservoir in which fluid can be stored and that is in fluid communication with the nipple. The body further comprises several pleats that allow the body to collapse and expand in an accordion-like fashion. This helps to prevent the infant from ingesting any air from within the container. Thus, Caso does not disclose a liquid dispensing pacifier that can be secured to various containers as desired by the user, and that also includes an elongated straw that can be secured to the pacifier.

Finally, U.S. Pat. No. 5,421,496 to Korsinsky et al. discloses a nipple or pacifier disposed on a tube that separates the pacifier from the bottle to which the tube is connected. Thus, the container or bottle can be hung in an elevated position while a user is feeding therefrom. While Korsinsky discloses a tube connected to a nipple, Korsinsky does not disclose a liquid dispensing pacifier that can be secured to various containers.

These prior art devices have several known drawbacks. Several devices in the prior art disclose specific types of pacifiers with internal reservoirs for storing a consumable substance therein. Such devices can only store a small amount of substance and may need to be refilled several times. These devices are not adapted for feeding a baby formula or other substance, but are only adapted to dispense a relatively small amount of fluid to the baby. Further, the devices in the prior art are not able to be configured into a pacifier or a bottle as desired by the user. Thus, the prior art devices require users to have several devices for feeding babies.

In light of the devices disclosed by the prior art, it is submitted that the present invention substantially diverges in design elements from the prior art and consequently it is clear that there is a need in the art for an improvement to existing liquid dispensing pacifier devices. In this regard the instant invention substantially fulfills these needs.

### SUMMARY OF THE INVENTION

In view of the foregoing disadvantages inherent in the known types of liquid dispensing pacifiers now present in the prior art, the present invention provides a new liquid dispensing pacifier wherein the same can be utilized for providing convenience for the user when feeding a baby or administering medicine to a baby.

It is therefore an object of the present invention to provide a new and improved liquid dispensing pacifier device that has all of the advantages of the prior art and none of the disadvantages.

It is another object of the present invention to provide a liquid dispensing pacifier that can be secured to a bottle for use as a traditional baby bottle.

Another object of the present invention is to provide a liquid dispensing pacifier that can be secured to a syringe so that medication can be administered through the pacifier.

Yet another object of the present invention is to provide a liquid dispensing pacifier that can be removably secured to an elongated straw to allow a baby to feed from the nipple without having to hold the container used to store the fluid.

Another object of the present invention is to provide a liquid dispensing pacifier that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the liquid dispensing pacifier as attached to an elongated straw.

FIG. 2 shows a perspective view of the liquid dispensing pacifier as attached to a baby bottle.

FIG. 3 shows a perspective view of the liquid dispensing pacifier as attached to a syringe.

### DETAILED DESCRIPTION OF THE INVENTION

Reference is made herein to the attached drawings. Like reference numerals are used throughout the drawings to depict like or similar elements of the liquid dispensing pacifier. For the purposes of presenting a brief and clear description of the present invention, the preferred embodiment will be discussed as used for dispensing consumable substances to a baby. The figures are intended for representative purposes only and should not be considered to be limiting in any respect.

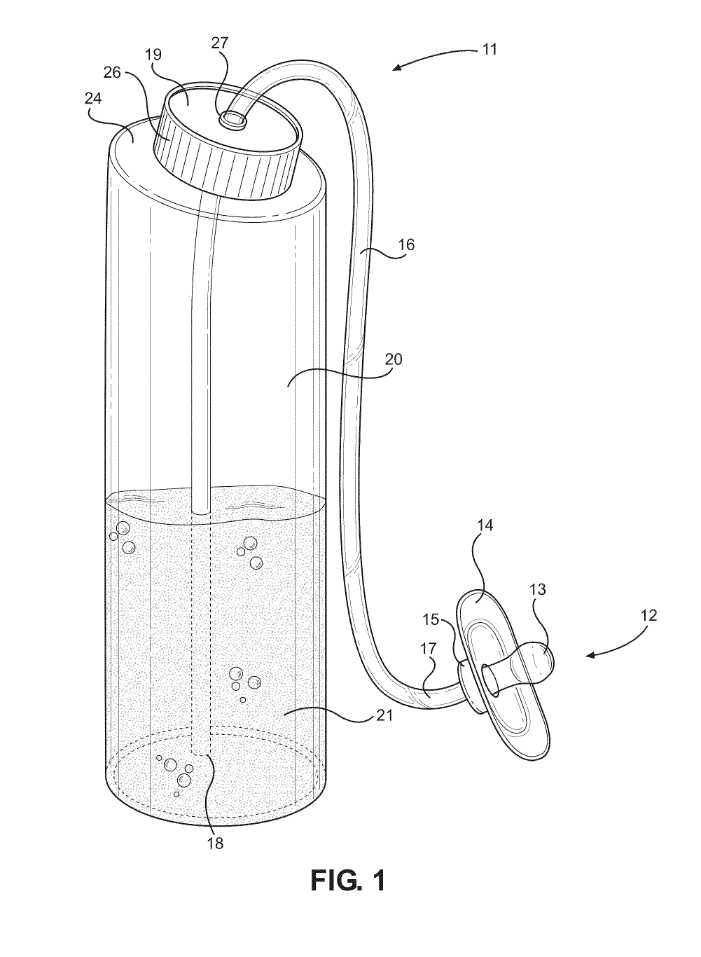

Referring now to FIG. 1, there is shown a perspective view of the liquid dispensing pacifier as attached to an elongated straw. The liquid dispensing pacifier with interchangeable parts 11 of the present invention includes a pacifier 12 that can be removably secured to an elongated straw 16, or directly to a container such as a baby bottle 20 or a syringe. The pacifier 12 comprises a nipple 13 that is hollow and porous. The nipple 13 preferably has a narrow neck with an opening and a bulbous end that is enclosed. The bulbous end of the nipple 13 comprises a plurality of apertures that allow fluid to pass therethrough, such that a baby can suck on the nipple 13 in order to consume the fluid within the pacifier 12.

The pacifier 12 further comprises a shield 14 disposed at the base of the nipple 13 adjacent to the narrow neck thereof. The shield 14 may have any of a variety of shapes, and may be shaped as a rectangle, oval, or circle. Further, the shield 14 may have an arcuate shape so as to better conform to the baby's lips. The shield 14 is composed of a semi-rigid material and helps to prevent the baby from drawing the nipple 13 too far into the baby's mouth so as to prevent the baby from swallowing and choking on the pacifier 12. The shield 14 is adapted to rest against a baby's lips and around the baby's mouth when the baby is sucking on the nipple 13 of the pacifier 12. The shield 14 is sized so that it does not fit within a baby's mouth. For an added measure of safety, the shield 14 may comprise one or more apertures therethrough such that in the event a baby or a young child swallows the pacifier 12, air can still pass through the shield 14 to allow the baby or child to breathe.

The pacifier 12 further comprises a base 15 that is adapted to be removably secured to various other components of the present invention. The base 15 comprises a cylindrical shape and preferably includes threading on the exterior surface thereof. The base 15 also comprises a central aperture therethrough, allowing for fluid to flow through said base 15, through said shield 14, and into the nipple 13.

The present invention further comprises an elongated straw 16 having a first end 17 and a second end 18, wherein each end 17, 18 is open. The elongated straw 16 is composed of a flexible, durable material. The first end 17 of the straw can be removably secured to the base 15 of the pacifier 12, such that the nipple 13 is in fluid communication with the elongated straw 16. The elongated straw 16 can be inserted into the central aperture on the base 15 and secured therein. Alternatively, the elongated straw 16 may comprise threading on the exterior of the first end 17 to provide a secure attachment to the base 15. Further, the first end 17 secures to the base 15 so as to provide a water-tight seal, to prevent leaks from occurring.

In the illustrated embodiment, the second end 18 of the elongated straw 16 is disposed within a baby bottle 20 in which baby formula or another consumable fluid 21 is stored. The elongated straw 16 is inserted through an opening 27 on the lid 19 of the container 20. The second end 18 of the elongated straw 16 is disposed within the liquid 21 in the container 20 so that when a baby sucks on the nipple 13, fluid is drawn from the container 20, through the straw 16, and into the nipple 13. In this way, the baby can suck on the nipple 13 and draw fluid from the bottle 20 without having to hold the bottle 20, which may be difficult for a baby, particularly when the bottle 20 is heavy or too large for the baby to hold.

The baby bottle 20 comprises a bottom, sidewalls, and an open upper end 24, defining an interior volume in which a consumable substance 21, such as baby formula, can be stored. The baby bottle 20 preferably has a cylindrical shape. The open upper end 24 of the baby bottle 20 is adapted to receive a lid thereon. The open upper end 24 may comprise a flange with threading thereon such that a lid can be threadedly engaged with the baby bottle 20 so that it can be held securely in place thereon.

A first lid 19 comprises an aperture 27 thereon that is adapted to receive the elongated straw 16 therethrough. The aperture 27 may further comprise a flexible ring or a gasket composed of rubber or other similar substance so as to provide a seal around the outside of the elongated straw 16. This helps to prevent any liquid from leaking through the aperture 27 when the straw 16 is inserted therethrough and the baby bottle 20 is inverted. The lid 19 may have a cylindrical shape, wherein the walls of the lid have ridges 26 thereon. The ridges 26 facilitate grasping the lid 19 so the user can easily screw the lid 19 onto and off of the baby bottle 20 or other container.

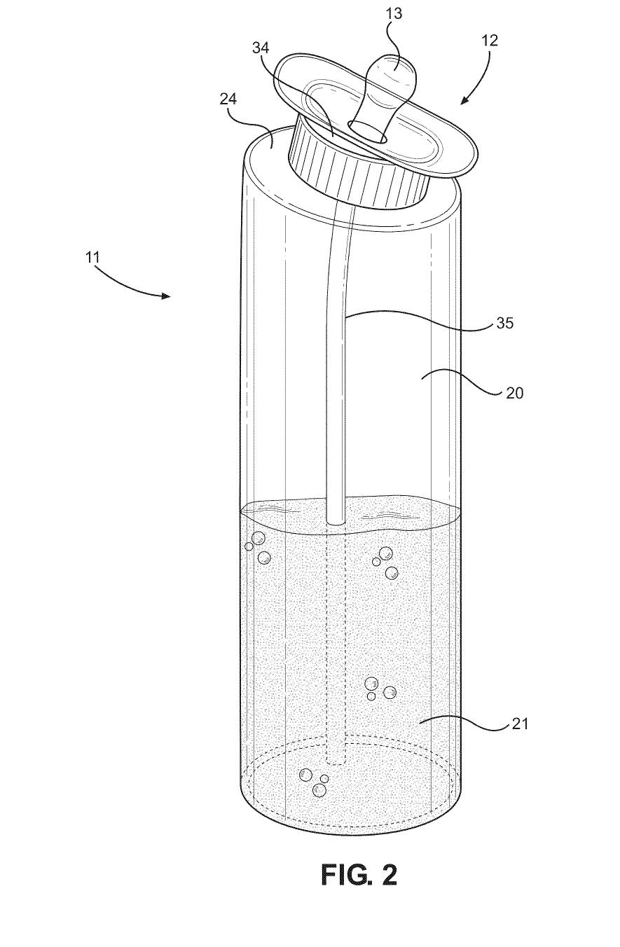

Referring now to FIG. 2, there is shown a perspective view of the liquid dispensing pacifier as attached to a baby bottle. The pacifier 12 of the present invention can be secured directly to the baby bottle 20. A second lid 34 may be provided that comprises an aperture adapted to receive the base of the pacifier 12. The second lid 34 is substantially similar to the first lid 19, however, the aperture on the second lid 34 is adapted to receive the base of the pacifier 12. The base of the pacifier 12 comprises threading thereon so that the base can be screwed into the aperture on the second lid 34. In this way, the pacifier 12 is secured to the baby bottle 20 such that the baby bottle can be used in the traditional fashion. The baby, or a parent or guardian, can hold the baby bottle and the baby can suck on the nipple 13 to draw fluid therethrough. In some embodiments of the present invention, the open upper end 24 of the baby bottle 20 is disposed at an angle relative to a horizontal axis. The angled, open upper end 24 facilitates drinking from the bottle in that the baby can more easily position the baby bottle 20 and thus the nipple 13 in a desired position for drinking.

When the pacifier 12 is secured directly to the lid 19 of the baby bottle 20, a shortened straw 35 may optionally be secured at a first end to the base of the pacifier 12, and includes a second end that is positioned within the fluid 21 within the baby bottle 20. The straw 35 is a shortened straw that is sized to fit within the baby bottle 20. In this way, when the baby sucks on the nipple 13, fluid 21 is drawn from within the baby bottle 20, through the straw 35 and into the nipple 13. This allows a baby to drink from the baby bottle 20 while the bottle 20 is in an upright position, since the fluid 21 can be drawn towards the nipple 13 through the straw 35.

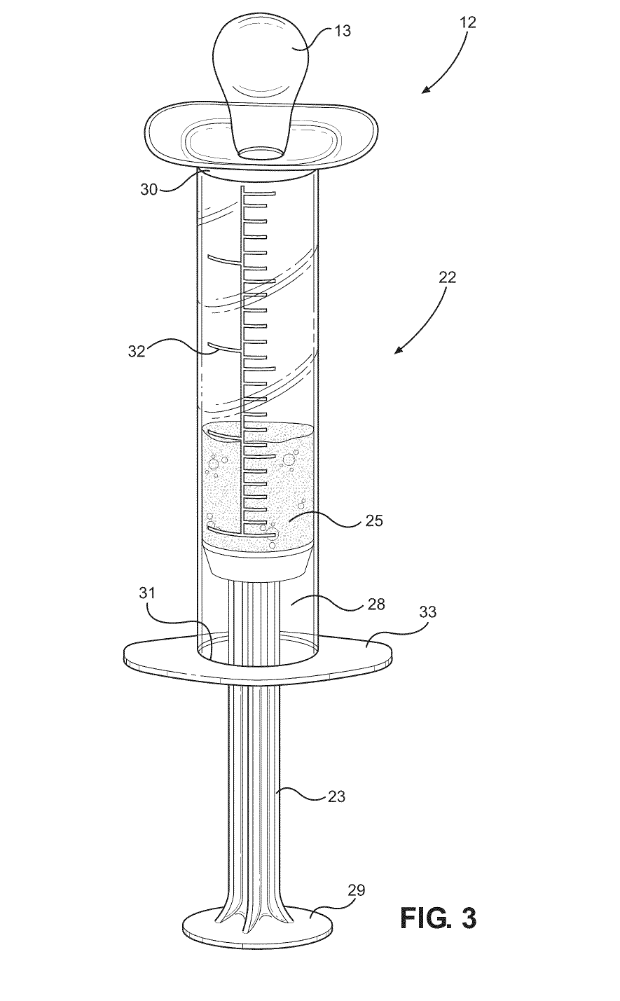

Referring now to FIG. 3, there is shown a perspective view of the liquid dispensing pacifier as attached to a syringe. The syringe 22 comprises an elongated barrel having an open upper end 30, and an open lower end 31 having an outwardly extending flange 33 thereon. The flange 33 helps the user to hold the syringe 22 when using the same. The elongated barrel may include graduated markings 32 thereon to help a user measure a desired amount of liquid medicine 25. The syringe 22 further includes a plunger 23 having a first end 28 that drives the liquid medicine 25 towards the nipple 13 and a second end 29 that extends outward from the syringe 22. The first end 28 of the plunger 23 has a flat, circular surface that is composed of rubber material. The first end 28 of the plunger 23 creates a fluid tight seal such that fluid within the syringe 22 cannot escape through the lower end 31 of thereof. The second end 29 comprises a flat, circular plate adapted to allow a user to depress the plunger 23.

The syringe 22 can be used to hold a measured volume of liquid medicine 25 for delivery to a baby. In operation, a parent or guardian can hold the syringe 22 so that the baby may suck on the nipple 13. The parent can then depress the second end 29 of the plunger 23 so as to move the first end 28 further into the elongated barrel of the syringe 22. The plunger 23 is depressed until the second end 29 is adjacent to the flange 33 of the elongated barrel. The combination of the syringe 22 and pacifier 12 may allow a parent or guardian to more easily provide medicine to a baby. The baby may be more receptive to taking medication since the baby is enabled to drink from the pacifier 12 at his or her own pace.

Thus, the present invention provides a liquid dispensing pacifier with interchangeable parts that can be arranged into various configurations. In this way, the present invention eliminates the need for a user to buy several different baby feeding devices and pacifiers. The user can attach the pacifier of the present invention to the elongated straw and dispose an end of the straw through a lid and into a baby bottle. The user can attach the pacifier directly to a second lid so that the baby bottle can be used in the conventional manner. Further, the pacifier may be used alone. The pacifier may also be secured to an end of a syringe in order to facilitate administration of medicine to a baby.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A liquid dispensing pacifier with interchangeable components, comprising:
a pacifier comprising a nipple having a hollow interior and an open end, a shield secured about said open end, and a base attached to said shield;
a baby bottle having an interior volume and an open upper end;
a lid having an aperture therethrough, wherein said lid is adapted to be secured onto said open end of said baby bottle
an elongated tubular straw having a first end and a second end, wherein a first end is removably secured to said base of said pacifier such that said straw is in fluid communication with said nipple, and wherein said second end is adapted to be disposed within said baby bottle having a consumable substance therein.

2. The liquid dispensing pacifier with interchangeable components of claim 1, wherein
said base of said pacifier comprises threading thereon, wherein said aperture of said lid comprises a threaded interior such that said base can be secured within said aperture.

3. The liquid dispensing pacifier with interchangeable components of claim 1, wherein
said lid has threading thereon, and wherein said open upper end of said baby bottle has threading thereon, such that said lid can be removably secured to said open upper end of said baby bottle.

4. The liquid dispensing pacifier with interchangeable components of claim 1, wherein said lid comprises ridges on an exterior surface thereof.

5. The liquid dispensing pacifier with interchangeable components of claim 1, wherein said aperture on said lid is adapted to receive an elongated tubular straw therethrough.

6. The liquid dispensing pacifier with interchangeable components of claim 5, wherein
said aperture on said lid comprises a rubber gasket such that a water-tight seal is created when said elongated straw is inserted in said aperture on said lid.

7. The liquid dispensing pacifier with interchangeable components, comprising:
a pacifier comprising a nipple having a hollow interior and an open end, a shield secured about said open end, and a base attached to said shield;
a syringe having a barrel and a plunger;
said barrel having an internal volume, a first end, and a second end;
wherein said first end of said barrel can be removably secured to said pacifier;
wherein said plunger is adapted to move within said barrel so as to move fluid disposed within said internal volume towards said pacifier.

8. The liquid dispensing pacifier with interchangeable components of claim 7, wherein
said first end of said barrel comprises threading on an interior surface thereof, and wherein said base of said pacifier comprises threading thereon, such that said pacifier can be removably secured to said first end of said barrel.
